(19) United States
(12) Patent Application Publication
(10) Pub. No.: US 2018/0225658 A1
(43) Pub. Date: Aug. 9, 2018

(54) METHODS FOR MANAGING A PLURALITY OF VIRTUAL CREDITS AND VIRTUAL WALLETS

(71) Applicant: RAZER (ASIA-PACIFIC) PTE. LTD., SINGAPORE (SG)

(72) Inventors: Zi Yang LIM, Singapore (SG); Chun How LEE, Singapore (SG)

(21) Appl. No.: 15/748,424

(22) PCT Filed: Jul. 28, 2015
(86) PCT No.: PCT/SG2015/050238

§ 371 Date: Jan. 29, 2018

(51) Int. Cl. G06Q 20/36; G06Q 20/06

(52) U.S. Cl. CPC G06Q 20/367; G06Q 20/065

(57) ABSTRACT

According to various embodiments, a method for managing a plurality of virtual credits may be provided. The method may include: managing a first virtual credit; and managing a second virtual credit.

### TECHNICAL FIELD

Various embodiments generally relate to methods for managing a plurality of virtual credits and virtual wallets.

### BACKGROUND

In-line with monetary regulations, a virtual credit which is purchasable via fiat money cannot be cash-out into fiat money, exchange for fiat money equivalent or physical products. A conventional single virtual credit system (e.g., Cherry Credits, MOL, KarmaKoins, Amazon Coins) abides to this limitation and when it is implemented as a payment system for a business, it can only be used for transaction of digital content and not into physical products. For example, Amazon Coins (a form of virtual credit) can be purchased using cash but amazon coins can only be used to purchase digital content such as apps, games and in-app items from Amazon devices or on their website.

Thus, there may be a need for improved virtual credits.

### SUMMARY OF THE INVENTION

According to various embodiments, a method for managing a plurality of virtual credits may be provided. The method may include: managing a first virtual credit; and managing a second virtual credit.

According to various embodiments, a virtual wallet may be provided. The virtual wallet may include: a first managing circuit configured to manage a first virtual credit; and a second managing circuit configured to manage a second virtual credit.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1A shows a flow diagram illustrating a method for managing a plurality of virtual credits according to various embodiments;

FIG. 1B shows a virtual wallet according to various embodiments;

FIG. 2 shows an illustration of Razer zVault (Elsa) according to various embodiments;

FIG. 3 shows a diagram illustrating a software (SW) ecosystem of Razer zVault (for example including various virtual credits) according to various embodiments;

FIG. 4 shows a diagram illustrating a hardware (HW) ecosystem of Razer zVault according to various embodiments; and

FIG. 5 shows an illustration of a block-chain utilization for chance-based reward for a digital resource farm according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In this context, the virtual wallet as described in this description may include a memory which is for example used in the processing carried out in the virtual wallet. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The reference to any prior art in this specification is not, and should not be taken as an acknowledgement or any form of suggestion that the referenced prior art forms part of the common general knowledge in Australia (or any other country).

In order that the invention may be readily understood and put into practical effect, particular embodiments will now be described by way of examples and not limitations, and with reference to the figures.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed or attached, or just in contact without any fixation, and it will be understood that both direct coupling or indirect coupling (in other words: coupling without direct contact) may be provided.

In-line with monetary regulations, a virtual credit which is purchasable via fiat money cannot be cash-out into fiat money, exchange for fiat money equivalent or physical products. A conventional single virtual credit system (e.g., Cherry Credits, MOL, KarmaKoins, Amazon Coins) abides to this limitation and when it is implemented as a payment system for a business, it can only be used for transaction of digital content and not into physical products. For example, Amazon Coins (a form of virtual credit) can be purchased using cash but amazon coins can only be used to purchase digital content such as apps, games and in-app items from Amazon devices or on their website.

In the digital online economy, there are many business entities using a single virtual credit system model for purchase of digital content.

Various embodiments address the transaction limitation of a cash-purchased virtual credit for digital content only. Referencing to Cherry Credits, MOL, KarmaKoins, Amazon Coins—all these virtual credits are only used for digital content purchases. There may be a transaction limitation because monetary regulations in most jurisdictions prohibit the conversion of virtual credit into fiat money to prevent money laundering.

According to various embodiments, a virtual credit wallet platform may be provided.

According to various embodiments, a dual virtual credit system for managing credit purchases, generation and consumption in a digital credit economy may be provided.

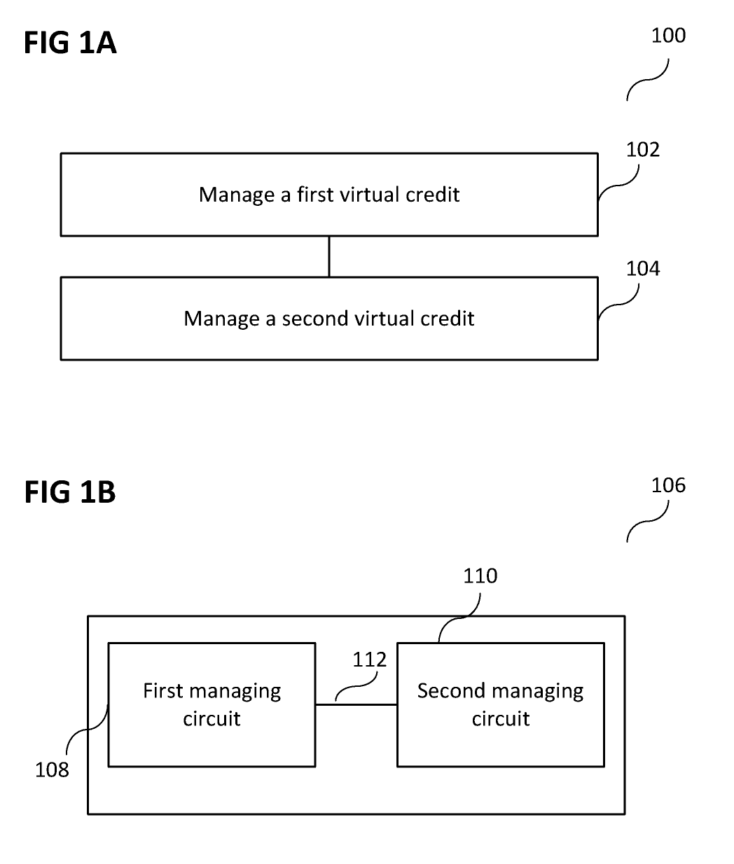

FIG. 1A shows a flow diagram 100 illustrating a method for managing a plurality of virtual credits according to various embodiments. In 102, a first virtual credit may be managed. In 104, a second virtual credit may be managed.

In other words, according to various embodiments, two different kinds (or currencies) of virtual credit may be managed.

According to various embodiments, the first virtual credit may include or may be or may be included in a primary virtual credit.

According to various embodiments, the first virtual credit may include or may be or may be included in a cash purchased virtual credit.

According to various embodiments, the first virtual credit may include or may be or may be included in zGold.

According to various embodiments, the second virtual credit may include or may be or may be included in a secondary virtual credit.

According to various embodiments, the second virtual credit may include or may be or may be included in rewards credits.

According to various embodiments, the second virtual credit may include or may be or may be included in enterprise issued rewards credits.

According to various embodiments, the second virtual credit may include or may be or may be included in zSilver.

According to various embodiments, the second virtual credit may be convertible into the first virtual credit.

According to various embodiments, managing the first virtual credit may include or may be or may be included in storing an amount of the first virtual credit of a user on a server.

According to various embodiments, managing the second virtual credit may include or may be or may be included in storing an amount of the second virtual credit of a user on a server.

According to various embodiments, the first virtual credit may be redeemable for virtual products.

According to various embodiments, the first virtual credit may be redeemable for virtual activities.

According to various embodiments, the first virtual credit may be redeemable for software purchase.

According to various embodiments, the second virtual credit may be redeemable for peripheral purchase.

FIG. 1B shows a virtual wallet 106 according to various embodiments. It will be understood that the virtual wallet 106 may be implemented as a computer, a computer system, a server. The virtual wallet 106 may be implemented in a cloud. The virtual wallet 106 may include a first managing circuit 108 configured to manage a first virtual credit. The virtual wallet 106 may further include a second managing circuit 110 configured to manage a second virtual credit. The first managing circuit 108 and the second managing circuit 110 may be coupled with each other, like indicated by line 112, for example electrically coupled, for example using a line or a cable, and/or mechanically coupled

According to various embodiments, the first virtual credit may include or may be or may be included in a primary virtual credit.

According to various embodiments, the first virtual credit may include or may be or may be included in a cash purchased virtual credit.

According to various embodiments, the first virtual credit may include or may be or may be included in zGold.

According to various embodiments, the second virtual credit may include or may be or may be included in a secondary virtual credit.

According to various embodiments, the second virtual credit may include or may be or may be included in rewards credits.

According to various embodiments, the second virtual credit may include or may be or may be included in enterprise issued rewards credits.

According to various embodiments, the second virtual credit may include or may be or may be included in zSilver.

According to various embodiments, the second virtual credit may be convertible into the first virtual credit.

According to various embodiments, managing the first virtual credit may include or may be or may be included in storing an amount of the first virtual credit of a user on a server.

According to various embodiments, managing the second virtual credit may include or may be or may be included in storing an amount of the second virtual credit of a user on a server.

According to various embodiments, the first virtual credit may be redeemable for virtual products.

According to various embodiments, the first virtual credit may be redeemable for virtual activities.

According to various embodiments, the first virtual credit may be redeemable for software purchase.

According to various embodiments, the second virtual credit may be redeemable for peripheral purchase.

According to various embodiments, a dual virtual credit system may be provided for managing credit purchases, generation and consumption in a digital economy. In conjunction with the primary virtual credit used in conventional single virtual credit models, a secondary virtual credit (zSilver credits) may be awarded and issued by an enterprise, i.e. it cannot be purchased by customers using fiat money, circumvents the transaction limitation of a single virtual credit model, and allows the secondary virtual credit to be exchanged for physical products.

The dual virtual credit model according to various embodiments may provide the flexibility for an organization to implement a payment solution involving a singular virtual credit wallet platform which can transact for both digital and physical products.

The methodological application of two different virtual credits to perform in a correlated manner according to various embodiments may allow creative positioning (as a marketing tool) and open new business opportunities which circumvents existing limitations of monetary regulations on singular cash-purchased virtual credits systems.

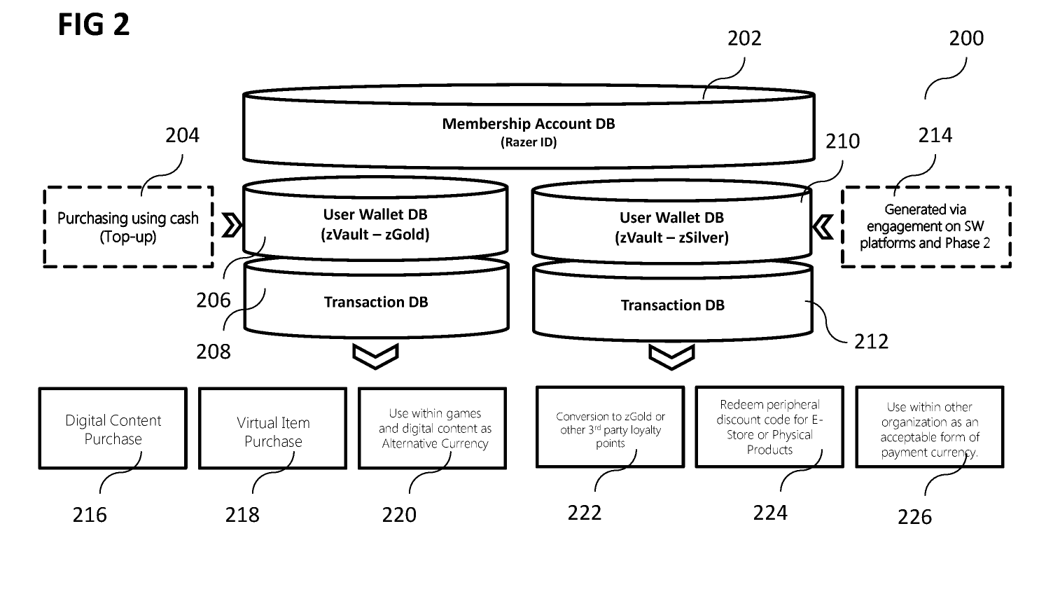

FIG. 2 shows an illustration 200 of Razer zVault (Elsa) according to various embodiments. A membership account database (DB) 202 may for example include Razer IDs (identifier) of various users. By purchasing using cash, like indicated by box 204, zGold in a first user wallet DB 206 may be topped up. zSilver in a second user wallet DB 210 may for example be generated (like illustrated by box 214) via engagement on software (SW) platforms and during “Phase 2”, which for example may include participating in a digital resource farm, like will be described in more detail below. A first transaction DB 208 may be provided in connection with the first user wallet DB 206. A second transaction DB 212 may be provided in connection with the first user wallet DB 210. zGold may be used for digital content purchase (like illustrated by box 216), for virtual item purchase (like illustrated by box 218), and/or for use within games and digital content as alternative currency (like illustrated by box 220). zSilver may be used for conversion to zGold or other third party loyalty points (like illustrated by box 222), for redemption of a peripheral discount code for e-store or physical products (like illustrated by box 224), and/or for use within other organizations as an acceptable form of payment currency (like illustrated by box 226).

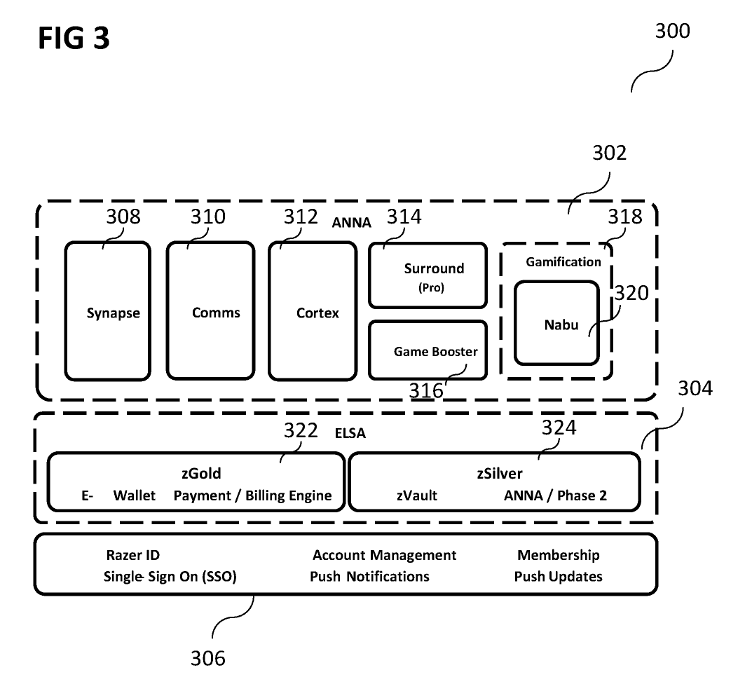

FIG. 3 shows a diagram 300 illustrating a software (SW) ecosystem of Razer zVault (for example including various virtual credits) according to various embodiments.

According to various embodiments, a system 304 for managing digital content and monetization (which may be referred to as Elsa: zVault, and which may be a credits and payment engine) may be provided. Elsa may include a credit purchase and payment engine for digital content (for example using zGolds 322) and micro-zGolds (for example zSilver 324).

According to various embodiments, a virtual credit wallet platform may include use of a dual virtual credit model that integrates with an enterprise's software and hardware ecosystem to manage credit purchases, generation and consumption. For example, an enterprise may sell electronic hardware products to customers. It also has a suite of software that can be used by users to interface with the electronic hardware in order to enable configurations on their electronic hardware products. In the example shown in FIG. 3, Synapse 308, Comms 310, Cortex 312, Surround (Pro) 314, Game Booster 316, and Gamification 318 (for example including a wristband, for example Nabu 320; it will be understood that gamification may also be referred to as gamification activity), which may all be part of a loyalty and socio-engagement platform, which may be referred to as Anna (like illustrated in box 302), may be software that provide users with the ability to interface with their hardware devices. Anna may provide a social wrapper (SW) around Synapse 308, Comms 310, Cortex 312 and the Nabu 320 software platform. Various embodiments may provide generation and consumption of zSilver across each SW vertical (ANNA or Anna). Anna may be integrated with multiple software and platforms to generate zSilver as a result of a user's engagement in gamification or socio-engagement activities. zSilver may then be consumed by users on zVault (Anna) for product exchanges. According to various embodiments, a zSilver generation engine for Wearables (Gamification activities) may be provided. zSilver may be used to exchange for physical products discount codes to drive sales to web-store. By integrating the virtual credit wallet platform (like illustrated in box 304 for two different virtual credits) with the suite of software, it allows the company to retain and engage users through high value creation and habit forming activities within the company's hardware and software ecosystem (like illustrated in box 306). It also allows the company to monetize digital content from the software. At the same time, there is loyalty retention and engagement of users in Razer's ecosystem across hardware and software.

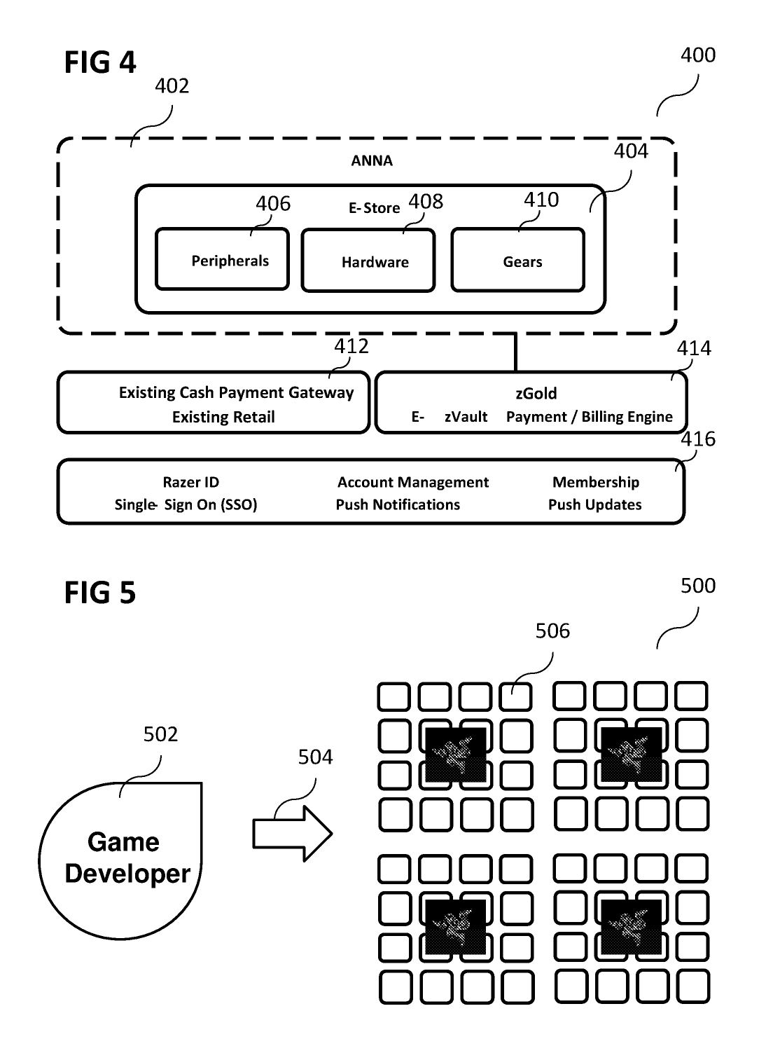

FIG. 4 shows a diagram 400 illustrating a hardware (HW) ecosystem of Razer zVault according to various embodiments.

According to various embodiments, the loyalty and socio-engagement platform, which may be referred to as Anna 402, may include an e-store 404. The e-store 404 may include peripherals 406, hardware 408, and gears 410. A cash payment gateway service 412 (for example including a payment engine (for example for cash, for example provided by a 3^{rd} party) may be provided. zGold 414 may be used as rewards to drive adoption into Razer's software ecosystem. Loyalty rebates in the form of zGold may be provided. Consumption of zGold for digital content may be possible. Razer may choose to award zSilver depending on business direction. By integrating the virtual credit wallet platform with the suite of software and hardware, it allows the company to retain and engage users through high value creation and habit forming activities within the company's hardware and software ecosystem (like illustrated in box 416).

According to various embodiments, zSilver may be paid-out as a reward virtual credits to users for contribution of their idle CPU (central processing unit) or GPU (graphics processing unit) processing power to Razer's Digital Resource Farm (zMine). According to various embodiments, block chain may be used to provide a random chance to earn a reward (zSilver) based on the assumption that the input (monetary contribution) by an enterprise using zMine is smaller than the total resource required for the task. This may help to maintain the attractiveness of the virtual credit value rather than diluting it to an insignificant amount.

FIG. 5 shows an illustration 500 of a block-chain utilization for chance-based reward for a digital resource farm according to various embodiments. A block-chain (in other words: with randomize rewarding) may be used according to various embodiments. According to various embodiments, a requester (for example a game developer 502) may engages zMine for a computational task (for example 60 mins game animation rendering) at a pre-determined price (for example USD$1,000). Like illustrated by arrow 504, 400,000 lots of resources 506 within zMine may be engaged for completion in 60 mins According to various embodiments, with Block-chain, not all lots may get rewarded, and based on randomize rewarding, 10,000 lots can get up to USD$0.10. As such a higher reward value for resources may be provided based on “chance” rather than equally distributing a fixed pre-determined price (for example USD$1,000) to all contributing lots of resources. The reward may be paid out as zSilver.

In the following, characteristics of a secondary virtual credit (for example zSilver) according to various embodiments will be described.

The secondary virtual credit (for example zSilver) may be part of the dual-credits systems for the Virtual Digital Wallet Platform. It may produce a sub-set credits (secondary) to zGold. It may be an incentive and gamification reward for user engagement with Razer's software platforms and on hardware (i.e. Nabu).

In the following, objectives of a secondary virtual credit (for example zSilver) according to various embodiments will be described.
A digital credits platform which allows each Razer software platforms to drive and develop gamification innovations to engage and retain users (based on DAU (daily active users) and MAU (monthly active users)).
Value-differentiation between Razer's close-loop ecosystem from competitors hardware retail business model.
Incentivize users to consistently use Razer products on a daily basis and drive software and product purchase on a 30 day cycle basis.

In the following, characteristics of a secondary virtual credit (for example zSilver) according to various embodiments will be described.
zSilver is a second credit which is a fraction of zGold. (10 zSilver=1 zGold or US$0.01).
This is a system generated and admin determined credit which cannot be purchased using cash.

In the following, economy control of a secondary virtual credit (for example zSilver) according to various embodiments will be described.
At any point in time, there can only be a fixed amount of zSilver in Razers Digital Economy (i.e. 50,000,000 or US$500,000)*. The availability of zSilver will be determined by:

1) Balance left in Razer's Economy

2) Total zSilver issued to user and remains un-utilize in E-Wallet and

3) Total zSilver utilized

4) Total zSilver deducted from users and returned to the Economy as admin fee
At any point in time, each user's Razer Digital Wallet can only hold 3000 zSilver.
Each user can only obtain 300 zSilver in a day via non-paid activities across all Razer's platform.
Each non-paid activity is limited to generate and disburse 20 zSilver a day per digital wallet. (Total number of gamification activities giving 20 zSilver: 15)
Additional zSilver can be awarded for digital purchases with a limit of 5% of product price in zSilver, up to 200 bonus zSilver per purchase (Which-ever is lower).
zSilver can be gifted to other existing Razer users (per account per day basis) with 10% transferred value in zSilver as admin fee.
zSilver can be converted to Razer Credits (once per day basis) to be utilize for game purchases in blocks of 1,000 zSilver (US$10).
zSilver can be redeemed for discount codes for Razer peripheral and gears purchase tied to the account (Once per account, per week).

zGold may, similar to a single virtual credit system, fulfils Razer's business requirements. Furthermore, the introduction of a secondary virtual credit which is deemed to be awarded by an Enterprise (not purchased by customers using fiat money) may circumvent the transaction limitation of a cash-purchased virtual credit and may allow it to be exchange for physical products.

From a business strategy perspective, a purchase of US$10 worth of zGold (1,000 Rz) may result in Razer rewarding the customer with 500 zSilver (US$0.50) as a marketing promotion. While zGold can only be used for digital content transactions, zSilver as a marketing reward when accrued and amassed, can be used for both digital and physical product exchange.

From a finance perspective, the acceptance of zSilver between two business entities may be deemed as a “Marketing partnership”. This may enable Razer to pay revenue to a physical product Merchant whom accept zSilver as a B2B arrangement. This is different from zGold as the partnership in agreement is deem as “Payment Service Agreement”.

According to various embodiments, a virtual credit wallet platform that manages credit purchases and credit payments. The virtual credit wallet platform manages credit purchases and credit payments. The system overcomes the regulations for virtual money that disallow the conversion or refund of virtual credits into the form of fiat money. A first virtual credit is used to purchase a hardware loaded with software. A second virtual credit is awarded. The second virtual credit is used with the software. Both virtual and real products may be obtained with the secondary virtual credit.

The virtual credit wallet platform overcomes the regulations for virtual money that disallow the conversion or refund of virtual credits into the form of fiat money. The system provides a second virtual credit that works in conjunction with the first virtual credit. The second virtual credit is awarded, rather than sold. This overcomes the regulations. The second virtual credit can be used, at least partially, to make purchases or participate in software that is integrated into hardware purchased with the primary virtual credit.

Thus, the virtual credit wallet platform addresses the limitation that is imposed on virtual credit purchased with fiat money. The method involves a dual virtual credit system. In conjunction with the primary virtual credit used in conventional single virtual credit models, a secondary virtual credit (zSilver) is awarded and issued by an enterprise. The secondary virtual credit cannot be purchased by customers using fiat money, circumvents the transaction limitation of a single virtual credit model, and allows the secondary virtual credit to be exchanged for physical products.

The application of two different virtual credits that work together allows creative positioning (as a marketing tool) and open new business opportunities which circumvents existing limitations of monetary regulations on singular cash-purchased virtual credits systems.

For example, an enterprise sells an electronic hardware products to customers with the first virtual credit. The enterprise also has a suite of software that can be used by users to interface with the electronic hardware in order to enable configurations on their electronic hardware products. Exemplary software includes Synapse, Comms, Surround, Game Booster. The software enables users to interface with their hardware devices. By integrating the virtual credit wallet platform with the suite of software, it allows the enterprise to retain and engage users through high value creation and habit forming activities within the company's hardware and software ecosystem. It also allows the company to monetize digital content from the software. At the same time, there is loyalty retention and engagement of users for both the hardware and software. And while the first virtual credit can only be used for digital content transactions, the secondary virtual credit is used as a marketing reward when accrued and amassed, and can be used for both digital and physical product exchange.

It will be understood that in the examples above, the application of the dual virtual credit system according to various embodiments is described from the perspective of Razer using the system; however, it will be understood that the system may have identical or similar effects for any other entity than Razer using it.

As used herein, zGold may be cash purchased virtual credits; zSilver may be enterprise issued rewards credits; the platform for the digital wallet according to various embodiments may also be referred to as zVault; the platform according to various embodiments may be referred to as zMine; the virtual credits may be referred to as zCopper (which may be another virtual credit which is a 1/10 fraction of zSilver). For example, zGold may correspond to US$0.01, zSilver may correspond to US$0.001, and zCopper may correspond to US$0.0001.

According to various embodiments, Razer zVault may include a membership account database (for example based on Razer ID), which may include a user zVault database for zGold including a transaction database (wherein zGold may be topped-up using cash or rebates from hardware purchase) and a user zVault database for zSilver including a transaction database (wherein zSilver may be generated via engagement on software platforms). zGold may be used for game software purchase, in a Razer gift economy (for example for virtual items or activities) or direct purchase within games (which may be referred to as credits exchange). zSilver may be converted to zGold, may be redeemed for peripheral discount code for e-store, or for direct integration within games for generation and usage.

The following examples pertain to further embodiments.

Example 1 is a method for managing a plurality of virtual credits, the method comprising: managing a first virtual credit; and managing a second virtual credit.

In example 2, the subject-matter of example 1 can optionally include that the first virtual credit comprises a primary virtual credit.

In example 3, the subject-matter of any one of examples 1 to 2 can optionally include that the first virtual credit comprises a cash purchased virtual credit.

In example 4, the subject-matter of any one of examples 1 to 3 can optionally include that the first virtual credit comprises zGold.

In example 5, the subject-matter of any one of examples 1 to 4 can optionally include that the second virtual credit comprises a secondary virtual credit.

In example 6, the subject-matter of any one of examples 1 to 5 can optionally include that the second virtual credit comprises rewards credits.

In example 7, the subject-matter of any one of examples 1 to 6 can optionally include that the second virtual credit comprises enterprise issued rewards credits.

In example 8, the subject-matter of any one of examples 1 to 7 can optionally include that the second virtual credit comprises zSilver.

In example 9, the subject-matter of any one of examples 1 to 8 can optionally include that the second virtual credit is convertible into the first virtual credit.

In example 10, the subject-matter of any one of examples 1 to 9 can optionally include that managing the first virtual credit comprises storing an amount of the first virtual credit of a user on a server.

In example 11, the subject-matter of any one of examples 1 to 10 can optionally include that managing the second virtual credit comprises storing an amount of the second virtual credit of a user on a server.

In example 12, the subject-matter of any one of examples 1 to 11 can optionally include that the first virtual credit is redeemable for virtual products.

In example 13, the subject-matter of any one of examples 1 to 12 can optionally include that the first virtual credit is redeemable for virtual activities.

In example 14, the subject-matter of any one of examples 1 to 13 can optionally include that the first virtual credit is redeemable for software purchase.

In example 15, the subject-matter of any one of examples 1 to 14 can optionally include that the second virtual credit is redeemable for peripheral purchase.

Example 16 is a virtual wallet comprising: a first managing circuit configured to manage a first virtual credit; and a second managing circuit configured to manage a second virtual credit.

In example 17, the subject-matter of example 16 can optionally include that the first virtual credit comprises a primary virtual credit.

In example 18, the subject-matter of any one of examples 16 to 17 can optionally include that the first virtual credit comprises a cash purchased virtual credit.

In example 19, the subject-matter of any one of examples 16 to 18 can optionally include that the first virtual credit comprises zGold.

In example 20, the subject-matter of any one of examples 16 to 19 can optionally include that the second virtual credit comprises a secondary virtual credit.

In example 21, the subject-matter of any one of examples 16 to 20 can optionally include that the second virtual credit comprises rewards credits.

In example 22, the subject-matter of any one of examples 16 to 21 can optionally include that the second virtual credit comprises enterprise issued rewards credits.

In example 23, the subject-matter of any one of examples 16 to 22 can optionally include that the second virtual credit comprises zSilver.

In example 24, the subject-matter of any one of examples 16 to 23 can optionally include that the second virtual credit is convertible into the first virtual credit.

In example 25, the subject-matter of any one of examples 16 to 24 can optionally include that managing the first virtual credit comprises storing an amount of the first virtual credit of a user on a server.

In example 26, the subject-matter of any one of examples 16 to 25 can optionally include that managing the second virtual credit comprises storing an amount of the second virtual credit of a user on a server.

In example 27, the subject-matter of any one of examples 16 to 26 can optionally include that the first virtual credit is redeemable for virtual products.

In example 28, the subject-matter of any one of examples 16 to 27 can optionally include that the first virtual credit is redeemable for virtual activities.

In example 29, the subject-matter of any one of examples 16 to 28 can optionally include that the first virtual credit is redeemable for software purchase.

In example 30, the subject-matter of any one of examples 16 to 29 can optionally include that the second virtual credit is redeemable for peripheral purchase.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for managing a plurality of virtual credits, the method comprising:
managing a first virtual credit;
managing a second virtual credit; and
rewarding the second virtual credit upon a purchase of the first virtual credit;
wherein the first virtual credit comprises a cash purchased virtual credit,
wherein the second virtual credit comprises rewards credits, and the second virtual credit is redeemable for physical products.

2. The method of claim 1,
wherein the first virtual credit comprises a primary virtual credit.

3. (canceled)

4. The method of claim 1,
wherein the first virtual credit comprises zGold.

5. The method of claim 1,
wherein the second virtual credit comprises at least one of a secondary virtual credit or enterprise issued rewards credits.

6.-7. (canceled)

8. The method of claim 1,
wherein the second virtual credit comprises zSilver.

9. The method of claim 1,
wherein the second virtual credit is convertible into the first virtual credit.

10. The method of claim 1,
wherein managing the first virtual credit comprises storing an amount of the first virtual credit of a user on a server.

11. The method of claim 1,
wherein managing the second virtual credit comprises storing an amount of the second virtual credit of a user on a server.

12. The method of claim 1,
wherein the first virtual credit is redeemable for at least one of virtual products, virtual activities, or software purchase.

13.-14. (canceled)

15. The method of claim 1,
wherein the second virtual credit is redeemable for peripheral purchase.

16. A virtual wallet comprising:
a first managing circuit configured to manage a first virtual credit; and
a second managing circuit configured to manage a second virtual credit;
wherein the first virtual credit comprises a cash purchased virtual credit,
wherein the second virtual credit comprises rewards credits, and the second virtual credit is redeemable for physical products; and
wherein the second virtual credit is rewarded upon a purchase of the first virtual credit.

17. The virtual wallet of claim 16,
wherein the first virtual credit comprises at least one of a primary virtual credit or a cash purchased virtual credit.

18. (canceled)

19. The virtual wallet of claim 16,
wherein the first virtual credit comprises zGold.

20. The virtual wallet of claim 16,
wherein the second virtual credit comprises a secondary virtual credit.

21. (canceled)

22. The virtual wallet of claim 16,
wherein the second virtual credit comprises enterprise issued rewards credits.

23. The virtual wallet of claim 16,
wherein the second virtual credit comprises zSilver.

24. The virtual wallet of claim 16,
wherein the second virtual credit is convertible into the first virtual credit.

25. The virtual wallet of claim 16,
wherein managing the first virtual credit comprises storing an amount of the first virtual credit of a user on a server.

26. The virtual wallet of claim 16,
wherein managing the second virtual credit comprises storing an amount of the second virtual credit of a user on a server.

27. The virtual wallet of claim 16,
wherein the first virtual credit is redeemable for at least one of virtual products, virtual activities, or software purchase.

28. (canceled)

29. (canceled)

30. The virtual wallet of claim 16,
wherein the second virtual credit is redeemable for peripheral purchase.
